(19) United States
(12) Patent Application Publication
(10) Pub. No.: US 2014/0023452 A1
(43) Pub. Date: Jan. 23, 2014

(54) Tack Screw

(71) Applicant: PEM Management, Inc., Wilmington, DE (US)

(72) Inventor: Michael J. Maloney, Doylestown, PA (US)

(21) Appl. No.: 13/937,329

(22) Filed: Jul. 9, 2013

Related U.S. Application Data
(60) Provisional application No. 61/672,320, filed on Jul. 17, 2012.

(51) Int. Cl. F16B 39/284

(52) U.S. Cl. CPC F16B 39/284
USPC 411/166

(57) ABSTRACT

The present clinch screw can be secured through a hole in a sheet of metal by a simple press-in application like a tack pin. An undercut clinch feature on the screw shank just underneath the head and above a threaded bulb portion of the shank secures the screw to the sheet as material from the sheet cold-flows into the undercut. Simultaneously, sheet material also flows around and between the bulb threads which forms partial female threads in the sidewall of the sheet hole and provides added pull-out resistance. The screw can then be simply turned out to remove it. In doing so additional female threads are cut into the upper portion of the hole sidewall as the threaded bulb moves upward and then out of the hole. A re-useable threaded hole in the sheet is left behind.

### RELATED APPLICATIONS

The present application is related to provisional patent application 61/672,320 entitled “Tack Screw” filed on Jul. 17, 2012 priority from which is hereby claimed.

### FIELD OF THE INVENTION

The present invention relates to clinch-type fasteners. More specifically, it relates to a pressed-in tack pin that can be removed without significant damage to the installation hole due to a threaded bulb on the shank of the pin which enables the tack pin to be removed by turning it out.

### BACKGROUND OF THE INVENTION

Tack pins are self clinching metallic fasteners that effectively tack a first thin sheet to a second sheet of metal by receiving the cold flow of metal from the second sheet into an undercut on the shank of the pin. Being harder than the panel into which they are being pressed tack pins are a strong method of attachment for thin metal assemblies. For the same depth of engagement, they can have greater pull out strength than a screw. Another advantage of tack pins is that they can be automatically installed by a machine simply by pressing the part on the head. No torque control or thread locking is necessary since the tack pin is retained by metal that has flowed into an undercut between its head and shank.

A problem exists however because the attachment of standard tack pins is permanent. There is currently no means of a non-destructive, controlled removal of these parts. Removing a tack pin effectively destroys the installation hole which cannot be re-used and re-assembly requires that new installation holes be created. Therefore there is a need in the art for a press-in clinching fastener which can be non-destructively removed and reinstalled.

### SUMMARY OF THE INVENTION

According to one embodiment of the screw of my new invention, a thread is added to the bulb on the shank of a tack pin similar to the pin of US patent 8,297,899 which is hereby incorporated by reference as though fully set forth. The screw can be pressed in like a pin but then unscrewed and re-used without destroying the receiving part. During installation, metal flows into the undercut of the part as well as into the thread valleys in the bulb. The tack screw can be removed by simple turning out via a variety of features such as employing a hex head and a complimentary tool driver.

When the tack screw is turned out, the thread on the shank bulb will push the tack pin upward with enough force to overcome the undercut clinch and also cut additional threads into the undercut material which has been pushed aside. A threaded hole in the bottom sheet which can be reused is created in the process. It will be appreciated from these features that a major advantage of the present tack screw is that it permits a non-destructive rework of an assembly.

The main features of the present tack screw for securing a top sheet to a bottom sheet include:
1) A head that retains a top sheet against a bottom sheet through aligned installation holes;
2) A shoulder to provide vertical clearance for the top sheet;
3) A displacer for clinching the screw into the bottom sheet that is provided by the bottom of the shoulder sized to the installation hole;
4) An undercut beneath the shoulder to be filled with displaced metal of the bottom sheet which retains the screw in the bottom sheet;
5) A shank including a threaded bulb which is sized relative to the installation hole in the bottom sheet to provide a slight interference fit; and
6) A tapered tip to aid in alignment of the tack pin when inserted into the installation holes.

According to one embodiment of the invention, the present tack screw is installed quickly by simply pressing downward on the head to force the shank of the screw through aligned apertures in the sheets to be joined. When metal flows from the bottom sheet into the undercut, it also flows into a helical thread on the shank bulb. Since there is a filled undercut above the bulb the tack screw of the invention is self- locking and will not loosen. Because there will be metal in the thread on the bulb the tack screw can be removed by turning the tack screw via the head in a direction that is counter to the direction of the thread. In the process of removing the tack screw a usable thread will also be formed in the top portion of the installation hole previously forced into the undercut. Either the same tack screw can be re-installed by turning it into the now-threaded installation hole, or a new screw can be used. This performance capability is achieved by the properly selected hardness of the screw and the material of the attached sheets, and their respective dimensions.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods, and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a bottom left isometric view of the invention.

FIG. 2 is a front cross-section view.

FIG. 3 is a front cross-section view.

FIG. 4 is a front cross-section view.

### DESCRIPTION OF THE PREFERRED EMBODIMENT

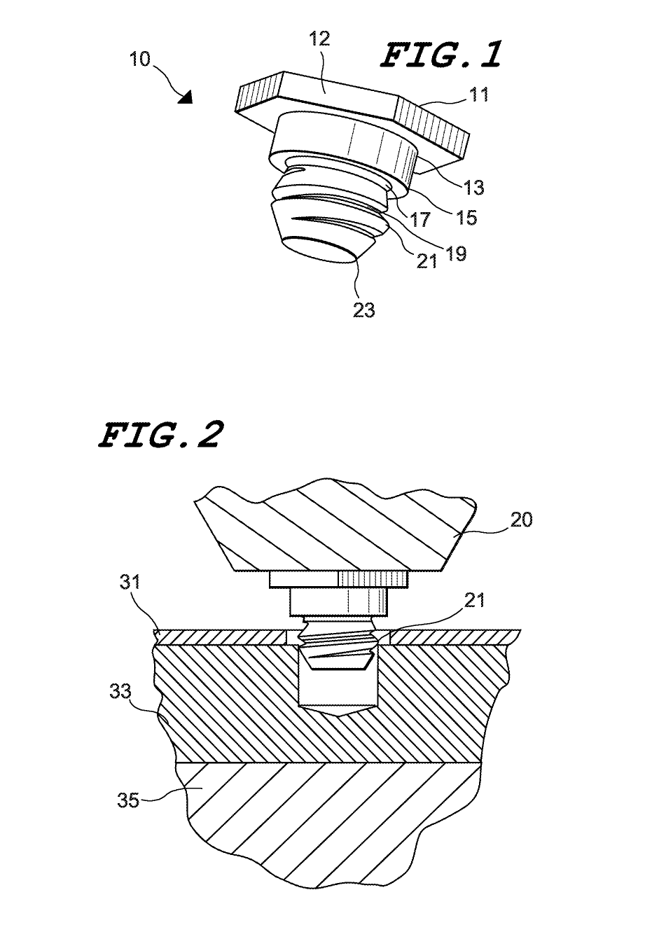

Referring now to FIG. 1, one embodiment of the tack screw 10 of the invention will now be described according to its various features presented in order from top to bottom. The screw is a metal fastener with a hex-shaped head 11 which is the largest diameter of the fastener and is employed for pressed-in installation against a top sheet to hold it against a bottom sheet. The hex head 11 includes flats 12 on its sides to provide drivable surfaces to turn out the pin after installation if necessary. A shoulder 13 occurs immediately below the head. The length of the shoulder provides vertical clearance for the top sheet and is approximately equal to its width plus the depth of penetration into the bottom sheet. As the screw is pressed in, the bottom of the shoulder 15 displaces metal from the bottom sheet into an undercut 17 directly beneath the shoulder and also into the threads 19 below the undercut. As the tack screw is pressed in, the undercut 17 gets filled with a cold flow of metal from the bottom sheet. This retains the pin in the bottom sheet and prevents any loosening of the threads 19. The shank of the screw is substantially barrel-shaped and includes a generally curved longitudinal profile that defines its bulbous shape. A bulb on the midsection of the shank tapers inwardly above and below its largest diameter and carries integral threads along its surface. The bulb is the largest diameter of the shank. At the bottom of the tack pin is a tapered tip 23 which aids in leading the part into the installation holes.

Referring now to FIG. 2, a pre-installation alignment of the tack screw of the invention is shown. The screw 10 is installed by a punch 20 through aligned apertures in the top and bottom sheets, 31 and 33 respectively, which are supported on the opposite side by an anvil 35. The largest diameter of the shank bulb 21 is dimensioned to provide a slight interference fit with the sidewalls of the installation hole in the bottom sheet.

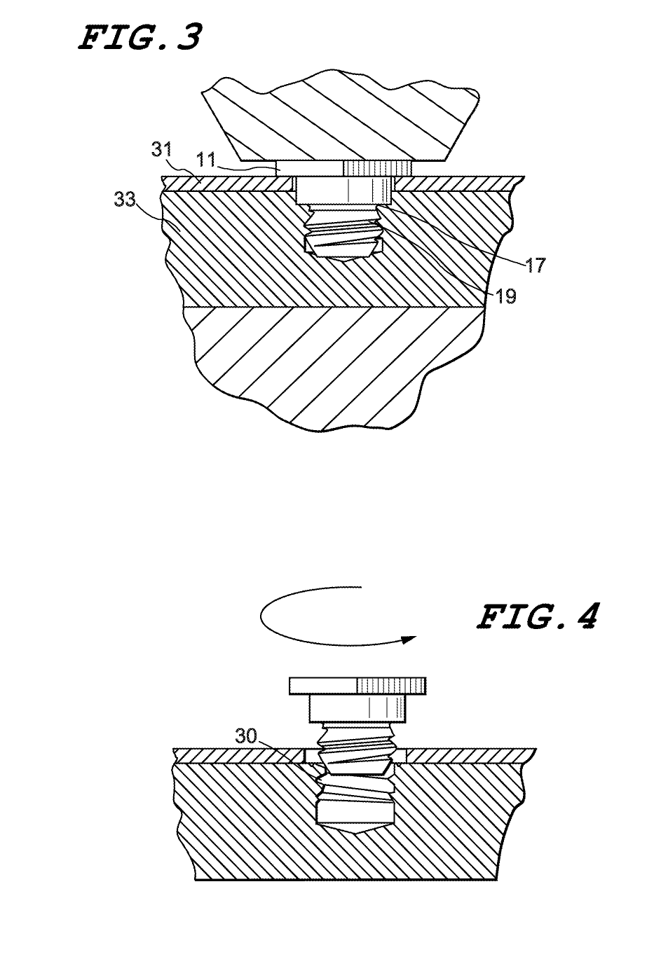

Referring now to FIG. 3, a fully installed tack screw is depicted. Here, the head 11 of the tack screw captures the top sheet 31 against the bottom sheet 33. It is retained to the bottom sheet by the cold flow of metal from the aperture sidewalls of bottom sheet into the undercut 17 and grooves of the threads 19 caused by the pressing force of the bottom of the shoulder. The sidewalls of the hole are thereby molded around the screw threads and thus become formed with a corresponding female thread profile which enables removal of the pin by turning it out. While the bottom sheet 33 is preferably metal the top sheet 31 may be of any appropriate composition. As shown in FIG. 4, the screw is now depicted being unscrewed which cuts additional female threads 30 into the upper portion of the hole previously occupied by the material from the undercut leaving re-useable threads behind.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. A metal-clinching tack screw for attachment to a metal sheet comprising:
a top most head being the largest diameter of the screw;
a shoulder extending axially downward from the head immediately below it, said shoulder having a bottom surface for displacing material from a sheet of metal into which it is installed;
a barrel-shaped shank beginning directly beneath the shoulder and further described as having sides of arcuate longitudinal cross-section which taper inwardly above and below a midsection bulb;
integral heilical screw threads on the outer surface of said bulb; and
an undercut located between the bottom of the shoulder and the bulb adapted to receive material displaced by said shoulder bottom surface.

2. The screw of claim 1 wherein said shank further includes a tapered bottom portion extending downward from said bulb to an end of the screw.

3. The screw of claim 2 wherein the diameter of the bulb is less than the diameter of the shoulder.

4. An assembly of tightly joined first and second sheets face-to-face comprising:
a top most head being the largest diameter of the screw;
a shoulder extending axially downward from the head immediately below it, said shoulder having a bottom surface for displacing material from a sheet of metal into which it is installed;
a barrel-shaped shank beginning directly beneath the shoulder and further described as having sides of arcuate longitudinal cross-section which taper inwardly above and below a midsection bulb;
integral heilical screw threads on the outer surface of said bulb;
an undercut located between the bottom of the shoulder and the bulb adapted to receive material displaced by said shoulder bottom surface;
a first sheet having a first aperture sized to closely receive the shoulder of said screw; and
a second sheet having a second aperture in alignment with said first aperture wherein the shank of the screw is rigidly secured to the second sheet by capture of the cold flow of material from the second sheet into the undercut and into the threads of the screw from sidewalls of the second aperture caused by axially pressing of the bottom of the shoulder into the second sheet.

5. The assembly of claim 4 wherein the aperture in the second sheet is a blind hole.

6. The assembly of claim 4 wherein said screw threads are adapted to cut corresponding threads into an upper portion of said second sheet upon rotational removal of the screw.

7. The assembly of claim 4 wherein the length of the shoulder is equal to the sum of the width of the top sheet and the depth of its penetration into the second sheet.

8. The assembly of claim 4 wherein the largest diameter of the shank bulb is sized to provide a slight interference fit with the second sheet sidewalls.
